(19) United States
(12) Patent Application Publication
(10) Pub. No.: US 2015/0058188 A1
(43) Pub. Date: Feb. 26, 2015

(54) Calculating Estimated Tax Payments

(71) Applicant: Thomson Reuters (Tax & Accounting) Services Inc., Carrollton, TX (US)

(72) Inventors: Paul David Bartlett, Dallas, TX (US); Steven M. Lynn, The Colony, TX (US); Maunang B. Mehta, Irving, TX (US); Binod K. Nair, Irving, TX (US); Kumar S. Unnikrishnan, Irving, TX (US)

(73) Assignee: Thomson Reuters (Tax & Accounting) Services Inc., Carrollton, TX (US)

(21) Appl. No.: 14/010,351

(22) Filed: Aug. 26, 2013

(51) Int. Cl. G06Q 40/00

(52) U.S. Cl. CPC G06Q 40/123
USPC 705/31

(57) ABSTRACT

Computing devices described herein are configured to determine income information associated with one or more entities and tax information for one or more jurisdictions associated with the one or more entities. The computing devices are further configured to calculate one or more estimated tax payments based at least in part on the income information and the tax information.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### TECHNICAL FIELD

The techniques presented herein relate to providing professional tax and accounting-related services, and more particularly, to robust computer-implemented, computer-assisted, and computer-integrated tools, resources, and processes for calculating estimated income tax payments for legal entities.

### BACKGROUND

In the United States, federal and many state and local constitutions, laws and regulations provide for their relevant taxing authorities to collect income taxes on a “pay-as-you-go” basis. In such systems, there are generally two ways to affect this. The first means is via a withholding tax and is generally applied as against wages, payments to foreign persons, and backup withholding on dividends and interest. Perhaps the most commonly familiar scenario with respect to the wage withholding tax occurs in the case of an individual who is legally considered an employee. In such case the employer withholds appropriate income tax from the employee's pay and remits that withholding to the appropriate taxing authority (e.g., the Internal Revenue Service in the case of federal income tax).

The second manner to collect “pay-as-you-go” income taxes is via an estimated tax. Estimated tax collection is the manner used to pay tax on income that is not subject to withholding. Federal, state, and some local jurisdictional tax laws require a periodic (generally, quarterly) payment of estimated income taxes due from those entities that have income not subject to withholding (e.g., corporations, trusts, estates, non-wage employees, and certain wage employees). For example, according to current federal income tax laws and regulations, a sole proprietor, partner, S corporation shareholder, and/or a self-employed individual generally is required to make estimated tax payments if it is expected to owe tax of $1,000 or more for that year. Standard C corporations generally must make estimated income tax payments if they expect their estimated tax liability to be $500 or more for that year. Even tax-exempt corporations, tax-exempt trusts, and domestic private foundations must make estimated tax payments in certain instances.

While preparation for and calculation of estimate income tax is generally relatively straightforward for individuals, it will be appreciated that for larger legal entities, for example, corporations, the task becomes more cumbersome and complex given the nature and breadth of their commercial enterprises. This time-intensive and labor-intensive process is compounded in the case of those corporations that have jurisdictional presences in multiple states where they may be subject to a wide array of complex and ever-changing state and local tax laws and regulations. However it is imperative for corporate accountants or other tax preparers for these larger legal entities to accurately determine the appropriate estimated income tax in order to avoid underpayment and other penalties levied by the relevant taxing authorities.

The estimated tax process generally involves corporate accountants or other tax preparers reviewing current assumptions and tax laws for accuracy and updates, gathering data, manually entering the data into Excel® spreadsheets, calculating the estimated tax payments, and then manually entering the results of those calculations into federal and state-approved vouchers. Some reports have suggested that, as a result, a typical large corporation may spend anywhere from five to ten weeks a year per accountant or other tax preparer simply extracting data from existing systems and then calculating estimated tax payments due.

### SUMMARY

The disclosure describes, in part, computing device(s) configured to determine income information associated with one or more entities and tax information for one or more jurisdictions associated with the one or more entities. The computing device(s) are further configured to calculate one or more estimated tax payments based at least in part on the income information and the tax information. In some embodiments, the computing device(s) may receive at least a part of the income information from a financial platform and may provide an indication of the one or more estimated tax payments to the financial platform. Additionally, the computing device(s) may be configured to automatically populate tax forms associated with the jurisdictions with at least representations of the estimated tax payments.

This Summary introduces a selection of concepts in a simplified form that are further described below in the Detailed Description. This Summary is not intended to identify key or essential features of the claimed subject matter; it is not to be used for determining or limiting the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an overview of one or more computing devices configured to calculate estimated tax payment(s) based at least in part on income information and tax information.

FIG. 2 illustrates an example system architecture including a calculation engine to calculate estimated tax payments, sources of income information and tax information, batch processors to invoke the calculation engine responsive to change(s) to the income information or tax information detected by trigger point(s), and a financial platform to provide income information and receive an indication of the calculated estimated tax payment(s).

FIG. 3 illustrates a component level view of a computing device configured with modules and data associated with calculating estimated tax payments.

FIG. 4 illustrates an example process for determining income information of one or more entities and tax information for jurisdictions associated with the one or more entities and for calculating one or more estimate tax payments based at least in part on the income information and the tax information.

### DETAILED DESCRIPTION

In the following description, various aspects of exemplary embodiments of the subject matter defined in the appended claims are described. For purposes of explanation and understanding, specific configurations and details are set forth in order to provide a thorough understanding of this claimed subject matter, and well-known and/or understood features may be omitted or simplified in order not to obscure this understanding. Furthermore, it will also be appreciated that the embodiments set forth herein may be practiced without the specific details presented. It will also be understood that these exemplary embodiments are not intended to be limiting, and those possessing ordinary skill in the art and having access to the teachings herein will recognize additional implementations, modifications, and embodiments, as well as other applications, which are fully contemplated herein as within the scope of what is disclosed and claimed herein.

### Overview

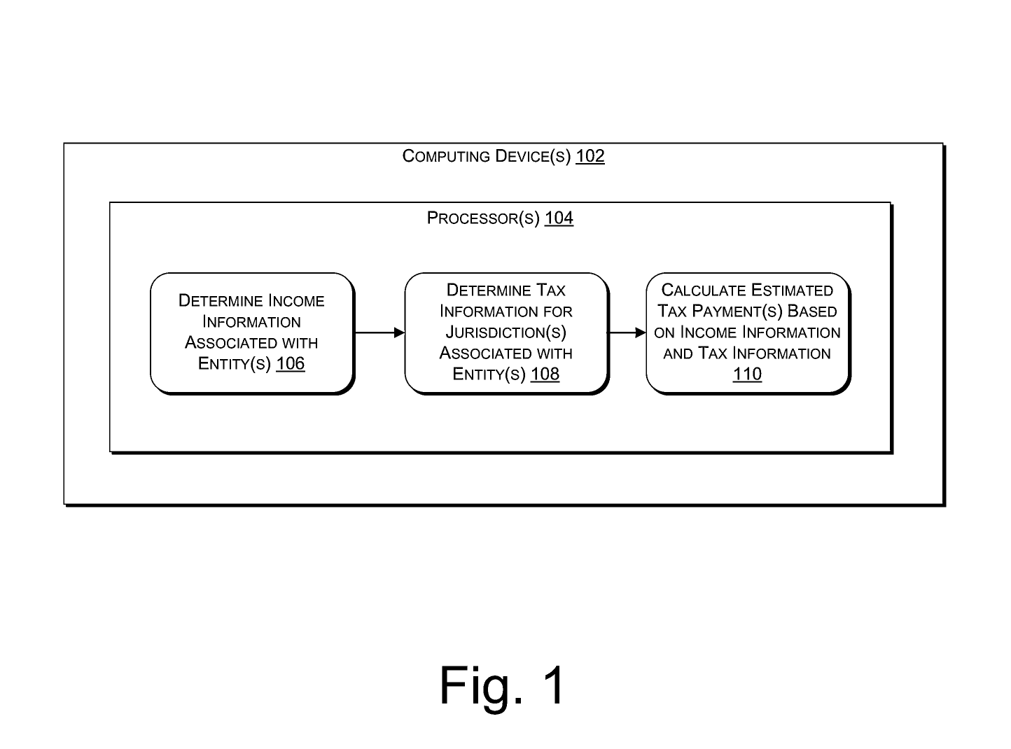

FIG. 1 illustrates an overview of one or more computing devices configured to calculate estimated tax payment(s) based at least in part on income information and tax information. As illustrated, one or more computing devices 102 may each have one or more processors 104. The processor(s) 104 execute programming instructions, including instructions causing the computing device(s) 102 to perform operations 106-110. At 106, the computing device(s) 102 determine income information associated with one or more entities. At 108, the computing device(s) 102 determine tax information for one or more jurisdictions associated with the one or more entities. At 110, the computing device(s) 102 calculate one or more estimated tax payments based at least in part on the income information and the tax information.

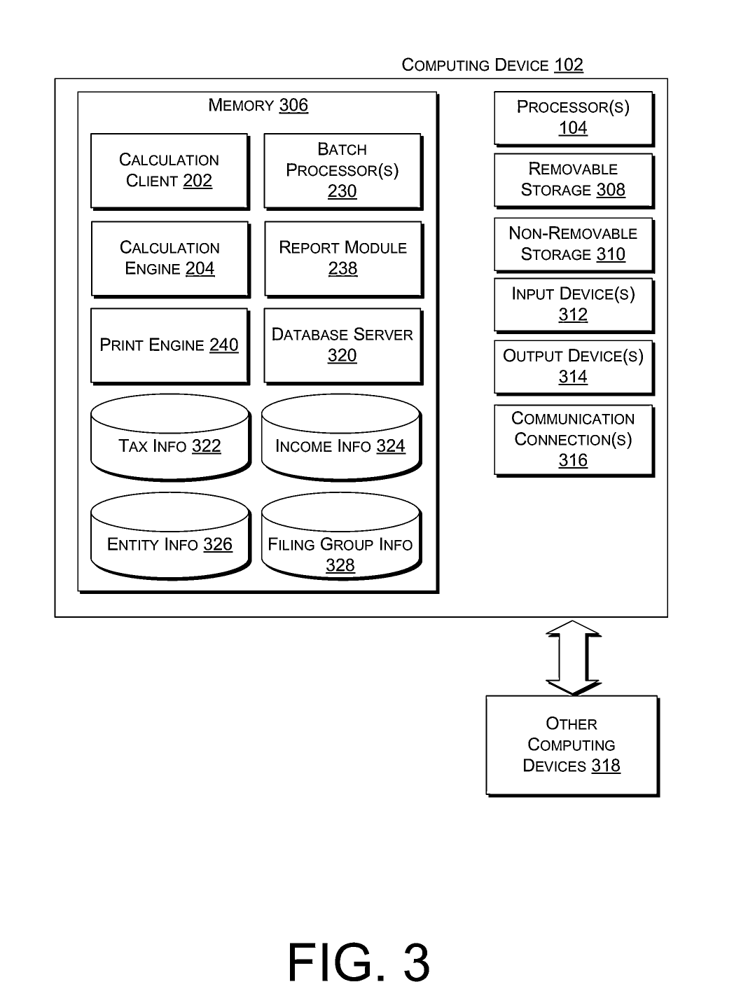

In various embodiments, each of the one or more computing devices 102 may be a server or server farm, multiple, distributed server farms, a mainframe, a work station, a personal computer (PC), a laptop computer, a tablet computer, a personal digital assistant (PDA), a mobile phone or other wireless device, a media center, an embedded system, or any other sort of device or devices. A computing device 102 may distribute the operations 106-110 illustrated in FIG. 1, with each computing device 102 performing a part of an operation 106-110, one of the operations 106-110, or multiple ones of the operations 106-110. In some implementations, the computing device(s) 102 represent a plurality of computing devices working in communication, such as a cloud computing network. In further implementations, one or more of the computing device(s) 102 represents one or more virtual machines. An example computing device capable of serving as a computing device 102 is illustrated in FIG. 3 and described below with reference to that figure.

When the one or more computing devices 102 includes multiple, networked computing devices, those computing devices may be connected by any one or more wired networks, wireless networks, or any combination thereof. Further, such network(s) may include any one or combination of multiple different types of public or private networks (e.g., wide access networks (WANs), local access networks (LANs), the Internet, etc.). In some instances, computing devices 102 communicate over the network(s) using a secure protocol (e.g., https) and/or any other protocol or set of protocols, such as the transmission control protocol/Internet protocol (TCP/IP).

In some embodiments, the one or more processors 104 may each be any of a central processing unit (CPU), a graphics processing unit (GPU), or both CPU and GPU, or other processing unit or component known in the art.

At 106, the computing device(s) 102 determine income information associated with one or more entities. The entities may be legal entities, such as corporations, limited liability companies, limited partnerships, etc. Such entities may also or instead include human persons. The determined income information may include income tax data, state apportionment data, tax provision data, or historical income data. The income information may be entered by a user through a user interface associated with the computing device(s) 102 or may be received from another source, such as a financial platform. Financial platforms, such as the Thomson Reuters ONESOURCE® tax accounting platform, may provide corporate tax and other professionals with automated processes that enable more accurate and efficient compliance with global tax regulations. The computing device(s) 102 may also enable users to view or edit income information through a user interface, and to create filing groups comprised of one or more entities. Alternatively or additionally, filing groups may be automatically created by the computing device(s) 102. Filing groups may be automatically created based on, for instance, tax laws and requirements of various jurisdictions. In some embodiments, determining the income information comprises determining income information for one or more entities associated with a filing group. Each calculation of one or more estimated tax payments may be performed for a particular filing group.

At 108, the computing device(s) 102 determine tax information for one or more jurisdictions associated with the one or more entities. Such tax information may include at least one of federal tax laws, state tax laws, tax formulas, tax calculation flows, tax rates, modification rates, graduated rates, payment options, tax adjustment options, tax credit options, calculating options, rounding options, filing methods, or tax forms. In some embodiments, business analysts may gather tax information from various sources and enter the information into the computing device(s) 102. In other embodiments, the computing device(s) 102 may automatically retrieve the tax information from one or more sources. The computing device(s) 102 may also provide a user interface that enables a user to review and edit the tax information. Further, the computing device(s) 102 may create multiple sets of tax laws for single jurisdiction. Such multiple sets of laws may reflect different user preferences or different filing group preferences. In some embodiments, determining the tax information comprises determining tax information for one or more jurisdictions associated with the above-mentioned filing group.

At 110, the computing device(s) 102 may calculate one or more estimated tax payments based at least in part on the determined income information and tax information. As mentioned above, in some embodiments, each calculation of one or more estimated tax payments is performed for a particular filing group. The computing device(s) 102 may apply the tax formulas, tax calculation flows, tax rates, modification rates, graduated rates, payment options, tax adjustment options, tax credit options, calculating options, and/or rounding options comprising the tax information to the income information to calculate the estimated tax payment(s). The computing device(s) 102 may perform the calculation in a non-consolidated mode (i.e., calculate a separate estimated tax payment for each single entity or combination of entity and jurisdiction), in consolidated mode (i.e., calculate, for each jurisdiction, an estimated tax payment for the combination of all of the entities in a filing group), or may perform the calculation in each of non-consolidated mode and consolidated mode.

The computing device(s) 102 may then use the estimated tax payment(s) to generate report(s) or to autopopulate tax forms for the jurisdictions associated with the filing group. Alternatively or additionally, the computing device(s) 102 may provide indicia of the estimated tax payment(s) to the financial platform for use by the financial platform in tax and other financial calculations.

Changes may occur to either or both of the income information or tax information following the determinations at 106-108 or calculation at 110. These changes may, for example, be detected by trigger point(s) of user interface(s) or of programming interface(s) and cause batch processor(s) of the computing device(s) 102 to invoke corresponding instances of a calculation engine of the computing device(s) 102 to recalculate the estimated tax payment(s). To reduce the computational burden involved in recalculating, the computing device(s) 102 may determine data objects impacted by the changes and perform the recalculation for those impacted data objects.

### Example Architecture

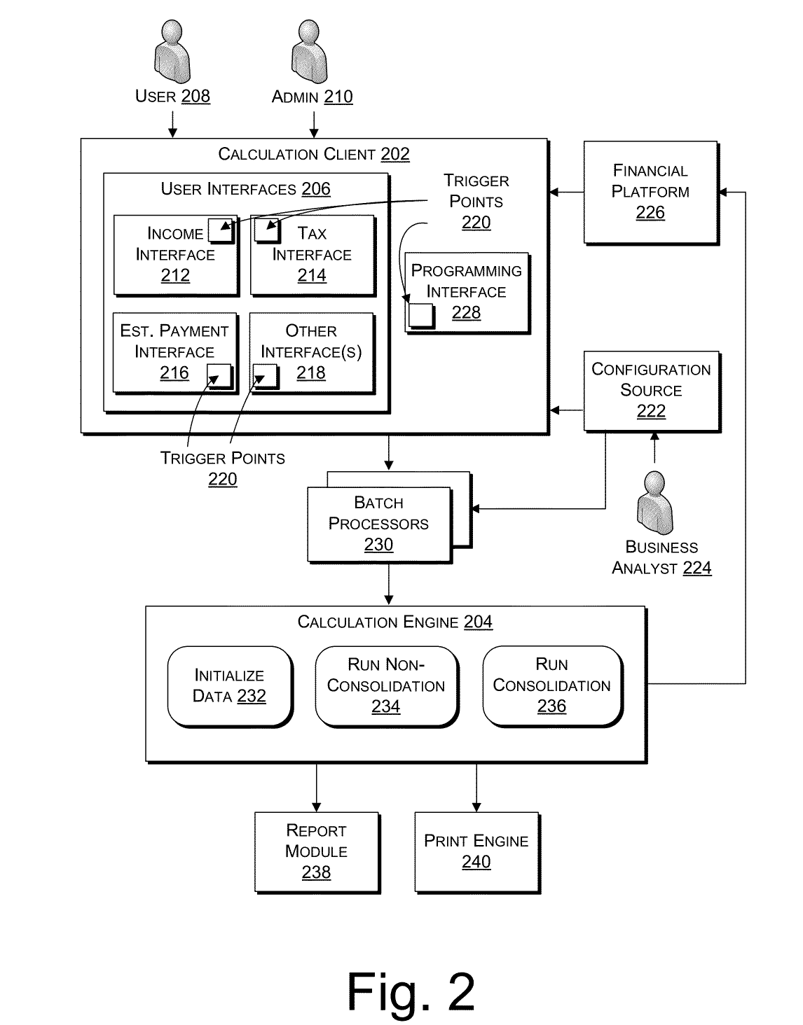

FIG. 2 illustrates an example system architecture including a calculation engine to calculate estimated tax payments, sources of income information and tax information, batch processors to invoke the calculation engine responsive to change(s) to the income information or tax information, and a financial platform to provide income information and receive an indication of the calculated estimated tax payment(s). As illustrated in FIG. 2, a calculation client 202 may provide income information and tax information to a calculation engine 204. The calculation client 202 may provide a number of user interfaces 206 to users 208 and administrative users 210 to enable input, review, and editing. Such user interfaces 206 may include an income information user interface 212, a tax information user interface 214, an estimated tax payments user interface 216, and one or more other user interfaces 218. The calculation client 202 may receive the income information and tax information from these user interfaces 206. Alternatively, or additionally, calculation client 202 may receive tax information from a configuration source 222. Such a configuration source 222 may provide tax information, such as tax laws, entered to the configuration source 222 by a business analyst 224. The calculation client 202 may also receive income information from a financial platform 226, which may communicate with the calculation client 202 through programming interface 228.

Changes or additions to income information or tax information may trigger a notification to one or more batch processors 230, which may in turn invoke corresponding instances of the calculation engine 204. The calculation engine 204 then, at 232, initializes data for estimated tax payment calculation(s). The calculation engine 204, at 234, calculates estimated tax payment(s) in non-consolidated mode or, at 236, calculates estimated tax payment(s) in consolidated mode, or calculates estimated tax payment(s) in both non-consolidated mode and consolidated mode. The calculation engine 204 then provides an indication of the estimated tax payment(s) to a report module 238 to generate one or more reports, to a print engine 240 to automatically populate tax form(s), or to the financial platform 226 for use in further tax calculations.

In various embodiments, the calculation client 202 and calculation engine 204 may each be implemented entirely or in part on an end user device or on a server device that is remote from the end user device. End user devices and server devices may each be any of the one or more computing devices 102 described above. For example, in some embodiments, the calculation client 202 and calculation engine 204 may be implemented on one or more server devices and provided as a web service to end user devices, which may access the user interfaces 206 of the calculation client 202 through web browsers. In other embodiments, the calculation client 202 may be implemented entirely or in part on an end user device (e.g., as an application or as a plug-in to a web browser) and the calculation engine 204 may be implemented on a server device. In yet other embodiments, both the calculation client 202 and calculation engine 204 may be implemented on end user devices, with configuration information (e.g., tax laws and other tax information) provided through a server device. These embodiments are described simply for illustrative purposes, and any number of alternative dispositions of the calculation client 202 and calculation engine 204 may be utilized.

The user interfaces 206 may be any sort of user interfaces, such as web pages provides via a web browser, user interfaces of an application installed on an end user device, or some combination thereof. The income information user interface 212 may be utilized by a user 208 (e.g., an end user) or an administrative user 210 to enter income information, such as income tax data, tax provision data, state apportionment data, or historical income data. The income information user interface 212 may have one or more entry screens to facilitate entry of the income tax information and may be provided in the form of a spreadsheet or other form which may be familiar to users 208. The income information user interface 212 may also enable a user 208 or administrative user 210 to import data from one or more other sources (e.g., spreadsheets) and to select a time period associated with the income information. Additionally, the income information user interface 212 may enable a user 208 or administrative user 210 to associate an existing filing group with the income information or to create a new filing group. Creating a new filing group may invoke an additional user interface 218, which may enable a user 208 or administrative user 210 to specify one or more entities (parent and subsidiary corporations, partnerships, etc.), jurisdictions (e.g., federal, various states, etc.), and a time period which may form the basis for estimated tax payment calculations. Alternatively or additionally, filing groups may be automatically created by the calculation client 202 and associated with income information (either automatically or through the income information user interface 212) based on, for instance, tax laws and requirements of various jurisdictions.

In some embodiments, the tax information user interface 214 may enable a user 208 or administrative user 210 to view all or a limited subset of tax laws, tax formulas, calculation flows, tax rates, modification rates, graduated rates, etc. for various jurisdictions. For example, the tax information user interface 214 may be provided in a convenient grid view with user-friendly options for viewing additional data or less data depending on user needs and may provide alerts and updates on tax law changes. The tax information user interface 214 may also enable a user 208 or administrative user 210 to select modifications, adjustments, or credits to change default laws for a jurisdiction, or to customize which laws to apply for a jurisdiction. Thus, the tax information user interface 214 may enable creation of multiple sets of tax laws for a given jurisdiction. The tax information user interface 214 may further enable a user 208 or administrative user 210 to create a filing group (in the manner described above) or to associate an existing filing group with a set of tax information associated with one or more jurisdictions of the filing group. The tax information user interface 214 may also enable a user 208 or administrative user 210 to specify calculation options or rounding options associated with tax information for one or more jurisdictions, and such calculation options or rounding options may be specific to a filing group. The tax information associated with a filing group may also specify filing methods, such as whether tax returns are to be filed in a non-consolidated or consolidated manner. The tax information user interface 214 may, in some cases, enable a user 208 or administrative user 210 to select a filing method associated with a jurisdiction of a filing group.

The estimated tax payments user interface 216 may display estimated tax payments calculated by the calculation engine 204 to enable a user 208 or administrative user 210 to view results and details of the estimated tax payment calculations and, if appropriate, to modify tax information or income information to cause the calculation engine 204 to recalculate the estimated tax payments.

The other user interfaces 218 may include a filing group user interface, such as the filing group user interface described above, and other user interfaces, such as an entity user interface which enables a user to specify information about an entity or information relating one or more entities (e.g., as parents and subsidiaries).

In some embodiments, each of the user interfaces 210, including the income interface 212, tax interface 214, estimated payment interface 216, or other interfaces 218 may include a trigger point 220 to detect changes. Additionally, a programming interface 228 may also include a trigger point 220. Upon capturing a change, a trigger point 220 converts data associated with the change into a form such as extensible markup language (XML) and creates or updates a process log which tracks the changes. The trigger point 220 then determines data impacted by the change. For example, if a change is made to income tax data, the trigger point 220 determines which filing groups, entities or time periods are associated with the changed income tax data and determines other data which is in turn associated with those filing groups, entities, or time periods. In some embodiments, the change may simply be new data, including new filing groups, new entities, new jurisdictions, etc.

In various embodiments, the configuration source 222 may be a system or component which receives tax laws, tax formulas, calculation flows, tax rates, modification rates, graduated rates, tax forms, etc. entered by a business analyst 224. The business analyst 224 may gather such tax information from various sources (e.g., websites or publications of various jurisdictions) and enter the tax information at the configuration source 222. In some embodiments, the business analyst 224 may build the calculation flows from tax formulas. Alternatively or additionally, the configuration source 222 may be a computing device or component of a computing device that automatically retrieves tax information from tax information source(s). In addition to tax information, the configuration source 222 may enable a business analyst 224 to specify or modify other configuration information for the calculation client 202 or calculation engine 204. The configuration source 222 may then provide the tax information or other information to the calculation client 204.

In some embodiments, the financial platform 226 may provide corporate tax and other professionals with automated processes that enable more accurate and efficient compliance with global tax regulations. Examples of such financial platforms 226 include the Thomson Reuters ONESOURCE® platform. The financial platform 226 may be a source of income information, such as income tax data, tax provision data, state apportionment data, and historical income data, and a recipient of estimated tax payment calculations produced by the calculation engine 204. The financial platform 226 may then include the one or more estimated tax payments in, for instance, a yearly tax return. To provide income information to the calculation client 202, the financial platform 226 may utilize a programming interface 228 of the calculation client 202. In further embodiments, the financial platform 226, calculation client 202, and calculation engine 204 may be integrated into a single software solution.

In various embodiments, the batch processor(s) 230 may be components that monitor or receive notifications from the trigger points 220 or various data sources. When a change is made to income information or tax information, one of the batch processor(s) 230 receives a notification of the change. Upon receiving notification of a change, the one of the batch processor(s) 230 invokes a corresponding instance of the calculation engine 204 to calculate one of more estimated tax payments based on income information and tax information, including the impacted data. In further embodiments, multiple batch processor(s) 230 may run in parallel to each other and invoke multiple instances of the calculation engine 204, which may also run in parallel to each other.

In various embodiments, the calculation engine 204 receives tax information and income information through batch processor(s) 230 and utilizes the tax information and income information to calculate estimated tax payment(s). At 232, the calculation engine 204 first initializes based on the received tax and income information. The calculation engine 204 identifies the filing group associated with the received information, as well as entities, jurisdictions, and a time period (e.g., payment period, quarter, year, etc.) associated with the filing group. In some embodiments, the calculation engine 204 also identifies or builds calculation and rounding options associated with a filing group. The calculation engine 204 then initializes with tax information associated with jurisdictions of a filing group. For example, the calculation engine 204 may initialize with tax rates from tax laws, with state modifications, with safe harbors, and with graduated rates. The calculation engine 204 may then load payment options, calculation options, and calculations flows. The calculation engine 204 then builds flow sequences from the calculation flows. Each item in the flow sequence may have an associated formula mapped in the calculation engine 204.

At 234, the calculation engine 204 may calculates estimated tax payment(s) for a filing group in non-consolidated mode. Calculating in non-consolidated mode refers to calculating estimated tax payments for different entities of a filing group separately. The calculation engine 204 may calculate in non-consolidated mode based on tax laws and rules of a jurisdiction of the filing group. For example, a filing group may include a parent corporation and a subsidiary corporation. In non-consolidated mode, the calculation engine 204 calculates estimated tax payments for each of the parent and the subsidiary separately. To calculate the estimated tax payment for a given entity and jurisdiction, the calculation engine 204 may execute the flow sequence for that jurisdiction, applying that flow sequence to income information associated with that entity. In some embodiments, the calculation engine 204 need not perform an entire calculation, but may simply execute parts of a flow sequence associated with the impacted data identified by the batch processor(s) 230.

At 236, the calculation engine 204 calculates estimated tax payment(s) for a filing group in consolidated mode. Calculating in consolidated mode refers to calculating an estimated tax payment for different entities of a filing group together. The calculation engine 204 may calculate in consolidated mode based on tax laws and rules of a jurisdiction of the filing group. For example, if a filing group includes a parent corporation and a subsidiary corporation, the calculation engine 204 may calculate a single estimated tax payment for both corporations for each jurisdiction of the filing group. To calculate the estimated tax payment for a given jurisdiction, the calculation engine 204 may execute the flow sequence for that jurisdiction, applying that flow sequence to income information associated with the entities of the filing group. In some embodiments, the calculation engine 204 need not perform an entire calculation, but may simply execute parts of a flow sequence associated with the impacted data identified by the batch processor(s) 230. Also, in some embodiments, the calculation engine 204 may calculate estimated tax payment(s) in both consolidated and non-consolidated modes. In further embodiments, the calculation engine 204 may simply calculate the estimated tax payment for a jurisdiction in consolidated mode by summing the estimated tax payments for that jurisdiction from non-consolidated mode.

Upon calculating estimated tax payments, the calculation engine 204 may persist the calculated estimated tax payments in storage and may make the estimated tax payments viewable through the estimated tax payment user interface 216 of the calculation client 202. In some embodiments, the estimated tax payment user interface 216 may enable the user 208 or administrative user 210 to lock the estimated tax payments or to trigger a recalculation, as described above.

In various embodiments, the calculation engine 204 may also provide the calculated estimated tax payments to any or all of a report module 238, a print engine 240, or the financial platform 226. The report module 238 may produce reports which include the calculated estimated tax payments for various filing groups, entities, jurisdictions, or time periods or which include a forecast of estimated tax payment(s). For example, the report module 238 may prepare reports that include projected cash flow, total payments by entity or jurisdiction, and total payments by quarter. The print engine 240 may automatically populate tax forms, such as tax vouchers, for various jurisdictions with representations of the estimated tax payments for those jurisdictions. For instance, a tax form for one jurisdiction may seek a consolidated estimated tax payment, and the print engine 240 may automatically populate that form with a representation of the consolidated estimated tax payment for that jurisdiction. Another jurisdiction may seek non-consolidated estimated tax payments on one or more forms, and the print engine 240 may automatically populate that form or those forms with representations of the non-consolidated estimated tax payments for that jurisdiction. In addition, the print engine 240 may further be configured to automatically populate the tax form(s) with other information needed to complete the tax form(s). In some embodiments, the print engine 240 or a component in communication with the print engine 240 may then provide the tax forms to a user 208 for display, review, and editing and may automatically submit the tax form(s) to taxing authority(s) of the jurisdiction(s). The print engine 240 may also save the tax form(s) for later review, revision, or submission.

### Example Device

FIG. 3 illustrates a component level view of a computing device 102 configured with modules and data associated with calculating estimated tax payments. As illustrated, computing device 102 comprises processor(s) 104, a memory 306, a removable storage 308, a non-removable storage 310, input device(s) 312, output device(s) 314 and communication connections 316 for communicating with other computing devices 318. The memory 306 may store modules such as the calculation client 202, the batch processor(s) 230, the calculation engine 204, the report module 238, the print engine 240, and a database server 320. The memory 306 may also store data, including tax information 322, income information 324, entity information 326, and filing group information 328.

In various embodiments, memory 306 is volatile (such as RAM), non-volatile (such as ROM, flash memory, etc.) or some combination of the two. Examples of components stored by memory 306, such as the calculation client 202, batch processor(s) 230, calculation engine 204, report module 238, and print engine 240 are described above in greater detail with reference to FIG. 2. While FIG. 3 illustrates the calculation client 202, batch processor(s) 230, calculation engine 204, report module 238, and print engine 240 being stored on a single computing device 102, it is to be understood that they may be distributed among multiple computing devices.

The database server 320 stored by memory 306 may be any sort of database server, such as a structure query language (SQL) server, and may provide access to data stored in memory 306, such as tax information 322, income information 324, entity information 326, and filing group information 328. The tax information 322 may include federal tax laws, state tax laws, tax formulas, tax calculation flows, tax rates, modification rates, graduated rates, payment options, tax adjustment options, tax credit options, calculating options, rounding options, filing methods, or tax forms. The income information 324 may include income tax data, tax provision data, state apportionment data, or historical income data. The entity information 326 may include any information associated with an entity, such as name, address, point of contact, etc. The filing group information 328 may include an identifier of the filing group, identifications of entities, jurisdictions, and a time period for the filing group, filing methods, calculation options, and rounding options.

The processor(s) 104 are described above in detail with respect to FIG. 1. In some embodiments, the computing device 102 may also include additional data storage devices (removable and/or non-removable) such as, for example, magnetic disks, optical disks, or tape. Such additional storage is illustrated in FIG. 3 by removable storage 308 and non-removable storage 310. Computer-readable media may include volatile and nonvolatile, removable and non-removable media implemented in any method or technology for storage of information, such as computer readable instructions, data structures, program modules, or other data. Memory 306, removable storage 308 and non-removable storage 310 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 102. Any such non-transitory computer-readable media may be part of the computing device 102.

Computing device 102 may also include input device(s) 312, such as a keyboard, a mouse, a touch-sensitive display, voice input device, etc., and output device(s) 314 such as a display, speakers, a printer, etc. These devices are well known in the art and need not be discussed at length here.

Computing device 102 also contains communication connections 316 that allow the computing device 102 to communicate with other computing devices 318, such as device(s) implementing a financial platform or user devices.

### Example Process

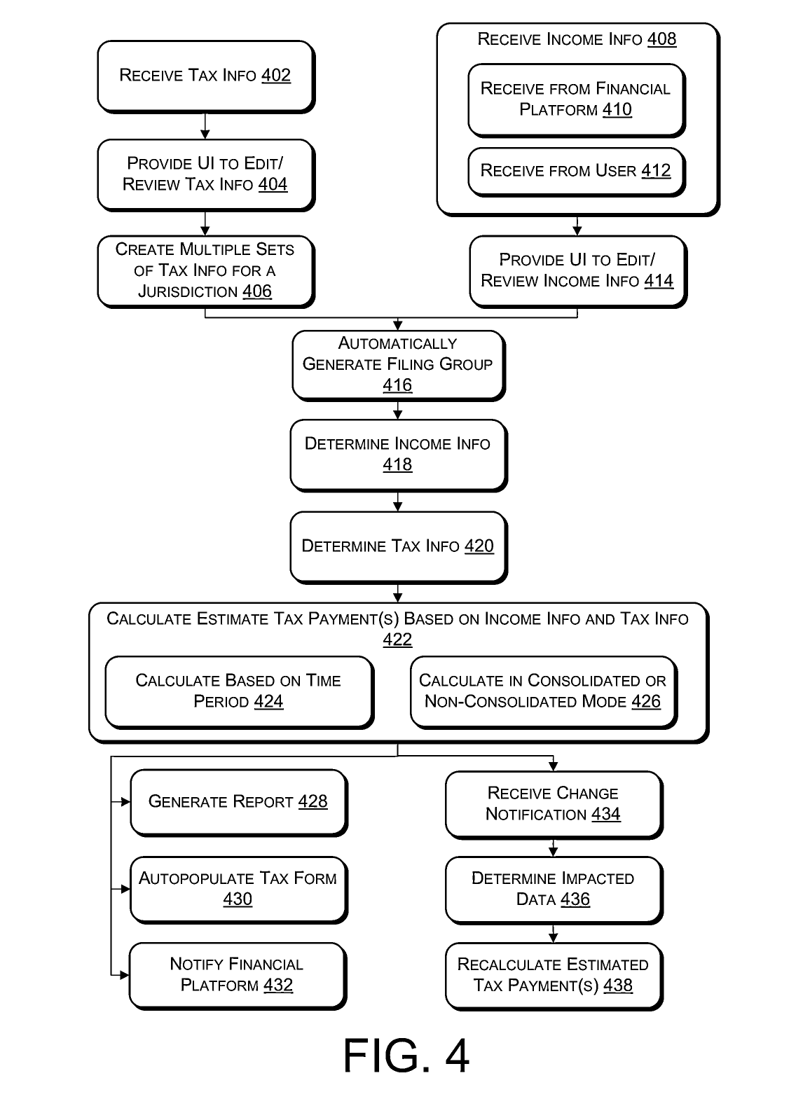

FIG. 4 illustrates an example process. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 4 illustrates an example process for determining income information of one or more entities and tax information for jurisdictions associated with the one or more entities and for calculating one or more estimate tax payments based at least in part on the income information and the tax information. The process includes, at 402, receiving, by one or more computing device, tax information for one or more jurisdictions. Such tax information may include at least one of federal tax laws, state tax laws, tax formulas, tax calculation flows, tax rates, modification rates, graduated rates, payment options, tax adjustment options, tax credit options, calculating options, rounding options, filing methods, or tax forms. In some embodiments, business analysts may gather tax information from various sources and enter the information into the one or more computing devices. In other embodiments, the one or more computing devices may automatically retrieve the tax information from one or more sources. At 404, the one or more computing devices may provide a user interface that enables a user to review and edit the tax information. For example, as mentioned above, the user interface may enable a user to review the latest tax laws for a jurisdiction in a convenient grid. Such user interfaces may be customizable. At 406, the one or more computing devices may create multiple sets of tax laws for single jurisdiction.

At 408, the one or more computing devices may receive income information associated with one or more entities. Such income information may include income tax data, tax provision data, state apportionment data, or historical income data. The one or more computing devices may receive the income information, at 410, from a data source, such as a financial platform or, at 412, via user entry through a user interface. At 414, the one or more computing devices provide a user interface that enables a user to review and edit the income information.

At 416, the one or more computing devices automatically create a filing group associated with one or more entities and one or more jurisdictions. In further embodiments, the one or more computing devices may enable a user to create a filing group. At 418, the one or more computing devices may determine income information for one or more entities, such as the one or more entities of a filing group. In some embodiments, the income information may be limited to income information having a connection to one or more jurisdictions, such as the one or more jurisdictions of the filing group. At 420, the one or more computing devices may determine tax information for one or more jurisdictions, such as the one or more jurisdictions of the filing group.

At 422, the one or more computing devices may calculate one or more estimated tax payments based at least in part on the determined income information and the determined tax information. Such a calculation may, for example, be performed for each filing group. At 424, the calculating is further based on a time period (e.g., a quarter or a year). At 426, the calculating is performed in either or both of a consolidation mode or a non-consolidation mode based at least in part on rules of the one or more jurisdictions.

After calculating the one or more estimated tax payments, the one or more computing devices may perform any one or more of the operations shown at 428-434. At 428, the one or more computing devices may generate reports that include at least one of the one or more estimated tax payments or which forecast estimated tax payment(s). At 430, the one or more computing devices may automatically populate a tax form of one of the one or more jurisdictions with at least one representation of a corresponding one of the one or more estimated tax payments. The one or more computing devices may further automatically populate the tax form with additional information that completes the tax form. At 432, the one or more computing devices may notify a financial platform of the one or more estimated tax payments by, for instance, providing indication(s) of the one or more estimated tax payments. The financial platform may then utilize the one or more estimated tax payments in one or more tax calculations.

At 434, the one or more computing devices receive a notification of a change to at least one of the income information or the tax information. The change notification may be received by a batch processor. At 436, the one or more computing devices determine one or more impacted data items associated with the income information or the tax information specified in the change notification. At 438, the one or more computing devices recalculate the estimated tax payments. The one or more computing devices may perform the recalculating on the one or more impacted data items.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method comprising:
determining, by one or more computing devices, income information associated with one or more entities;
determining, by the one or more computing devices, tax information for one or more jurisdictions associated with the one or more entities;
calculating, by the one or more computing devices, one or more estimated tax payments for a location in the one or more jurisdictions based at least in part on the income information and the tax information, wherein the one or more computing devices performs a first number of calculations when calculating the one or more estimated tax payments;
detecting a change in at least one of the income information or the tax information;
determining, at least partially in response to detecting the change, a subset of data impacted by the change; and
calculating an additional one or more estimated tax payments for the location based at least in part on the subset of data, wherein the one or more computing devices is required to perform a second number of calculations less than the first number when calculating the additional one or more estimated tax payments.

2. (canceled)

3. (canceled)

4. The method of claim 1, wherein the income information includes at least one of income tax data, tax provision data, state apportionment data, or historical income data.

5. The method of claim 1, further comprising receiving the income information from a financial platform or via user entry.

6. The method of claim 1, further comprising providing a user interface that enables a user to review and edit the income information;
providing, via the user interface, the tax information for the one or more jurisdictions, wherein the tax information is provided in a grid including indicia visually associating the tax information with the corresponding one or more jurisdictions;
receiving an input from the user via the user interface; and
modifying an amount of the tax information provided via the user interface in response to the input.

7. The method of claim 1, wherein the tax information includes at least one of federal tax laws, state tax laws, tax formulas, tax calculation flows, tax rates, modification rates, graduated rates, payment options, tax adjustment options, tax credit options, calculating options, rounding options, filing methods, or tax forms.

8. The method of claim 7, further comprising providing a user interface that enables a user to review and edit the tax information.

9. The method of claim 7, further comprising creating multiple sets of tax laws for single jurisdiction.

10. The method of claim 7, further comprising:
notifying a user of a change to a tax law, a tax formula, a tax rate, or a tax option by displaying a changed tax law, tax formula, tax rate, or tax option on a user interface; and
providing the user with an option for viewing, on the user interface, more or less data related to the changed tax law, tax formula, tax rate, or tax option.

11. The method of claim 1, wherein the calculating is further based on a time period.

12. The method of claim 1, wherein the calculating is performed in either or both of a consolidation mode or a non-consolidation mode based at least in part on rules of the one or more jurisdictions.

13. The method of claim 1, wherein the calculating further comprises converting a tax calculation flow included in the tax information into a tax flow sequence with mapped tax formulas.

14. The method of claim 1, further comprising:
automatically creating a filing group associated with the one or more entities and the one or more jurisdictions or enabling specification by a user of the filing group; and
calculating the one or more estimated tax payments for the filing group.

15. The method of claim 1, further comprising at least one of:
generating reports that include at least one of the one or more estimated tax payments;
automatically populating a tax form of one of the one or more jurisdictions with at least one representation of a corresponding one of the one or more estimated tax payments; or
notifying a financial platform of the one or more estimated tax payments.

16. One or more non-transitory computer-readable media having stored thereon computer programming instructions which, when executed by a processor, cause a computing device to perform operations comprising:
retrieving, from a financial platform, income information associated with one or more entities;
determining tax information for one or more jurisdictions associated with the one or more entities;
calculating one or more estimated tax payments for a location in the one or more jurisdictions based at least in part on the income information and the tax information, wherein the processor performs a first number of calculations when calculating the one or more estimated tax payments;
providing an indication of the one or more estimated tax payments to the financial platform;
detecting a change in at least one of the income information or the tax information;
determining, at least partially in response to detecting the change, a subset of data impacted by the change; and
calculating an additional one or more estimated tax payments for the location based at least in part on the subset of data, wherein the processor is required to perform a second number of calculations less than the first number when calculating the additional one or more estimated tax payments.

17. The non-transitory one or more computer-readable media of claim 16, wherein retrieving the income information from the financial platform comprises retrieving at least one of tax provision data, state apportionment data, income tax data, or historical income data from the financial platform.

18. The one or more non-transitory computer-readable media of claim 16, wherein the financial platform utilizes the one or more estimated tax payments in one or more tax calculations or other financial calculations.

19. A system comprising:
one or more processors;
one or more trigger points operable on an interface in communication with the one or more processors;
a calculation engine that, when executed by the one or more processors, performs operations including:
determining income information associated with one or more entities,
determining tax information for a jurisdiction associated with the one or more entities,
calculating an estimated tax payment for a location in the jurisdiction based at least in part on the income information and the tax information, wherein the one or more processors performs a first number of calculations when calculating the estimated tax payment,
determining, at least partially in response to a change in either the income information or the tax information detected by the one or more trigger points, a subset of data impacted by the change, and
calculating an additional estimated tax payment for the location based at least in part on the subset of data, wherein the one or more processors is required to perform a second number of calculations less than the first number when calculating the additional estimated tax payment; and
a print engine that, when executed by the one or more processors, automatically populates a tax form associated with the jurisdiction with at least a representation of the estimated tax payment.

20. The system of claim 19, wherein the print engine automatically populates the tax form with additional information that completes the tax form.

21. The system of claim 19, further comprising a batch processor that, when executed by the one or more processors, receives data change notifications and invokes the calculation engine.

22. The system of claim 21, further comprising multiple batch processors for corresponding multiple instances of the calculation engine which operate in parallel with each other.

23. The method of claim 1, wherein calculating the one or more estimated tax payments imposes a first computational burden on the one or more computing devices, and wherein calculating the additional one or more estimated tax payments imposes a second computational burden on the one or more computing devices less than the first computational burden.

24. The method of claim 1, further including converting, at least partially in response to detecting the change, the subset of data impacted by the change to extensible markup language, and storing information indicative of the change in a process log associated with the one or more computing devices, wherein the information includes at least a portion of the extensible markup language.
